(19) United States
(12) Patent Application Publication
(10) Pub. No.: US 2017/0138100 A1
(43) Pub. Date: May 18, 2017

(54) DOORWAY ENTRY PREVENTION DEVICE

(71) Applicants: Brandon Zolman, Fredericktown, OH (US); Rick Shaffer, Mt. Vernon, OH (US)

(72) Inventors: Brandon Zolman, Fredericktown, OH (US); Rick Shaffer, Mt. Vernon, OH (US)

(21) Appl. No.: 15/355,640

(22) Filed: Nov. 18, 2016

Related U.S. Application Data
(60) Provisional application No. 62/257,013, filed on Nov. 18, 2015.

(51) Int. Cl. E05C 19/00; E05B 1/00; E05C 19/18

(52) U.S. Cl. CPC E05C 19/003; E05C 19/184; E05B 1/003

(57) ABSTRACT

The present invention is a system and method for quickly securing a door to a door frame to protect the occupants of a room from an intruder while still allowing a user to open the door from within the secured room with a minimum of movements and time in the event of a dangerous situation in the room such as fire or other hazards. Embodiments of the invention are equally applicable to doors that open inwardly and outwardly relative to an area to be secured.

### CROSS-REFERENCE TO RELATED APPLICATION

This application claims priority to provisional application 62/257,013 filed on Nov. 18, 2015 and is incorporated by reference in its entirety as if fully recited herein.

### TECHNICAL FIELD

Exemplary embodiments of the present invention relate generally to devices for preventing unauthorized entry to a classroom or other enclosed areas.

### BACKGROUND AND SUMMARY OF THE INVENTION

As the result of an unfortunate number of school shootings in which an intruder has entered a school building with a firearm or other weapon, there is a need to be able to quickly secure a classroom or other door against intrusion. Various methods have been suggested that require modifications to the building or door structures including patent application numbers US 2015/0204122 and US 2015/0137534. Other methods require the existing door latch be set to a “locked” setting and prevent the door from latching completely until the invention is disengaged (patent application numbers US 2014/0333075 and 2010/0102573). Applicable fire safety requirements are of particular concern for devices that prevent the opening of a doorway used in public buildings such as schools. In order to be compliant with many such standards, an occupant of a locked room must be able to exit the room with a single action. For example, moving a door handle to an unlocked position as the occupant presses against the doorway in order to exit. What is needed is a device for securing a doorway that can easily be added to an existing door without significant modification of the door or building structure. Such a system should not require additional components that must be added to the door during use and ideally should not require more than a single movement to engage. In order to comply with fire code requirements, the system should not require more than a single movement to open the door in the event of a fire or other circumstance in which the secured area must be evacuated.

In an embodiment of the invention, a door securing plate may be mounted to a doorknob such that the plate may rotate about the shaft of the doorknob. In such an embodiment, the rotation of the plate may be restricted by frictional interference between the shaft and the plate such that the plate will remain stationary with respect to the door to which it is attached. When desired, the door securing plate may be rotated to a point at which it extends beyond the edge of the door. In certain embodiments of the invention, when the door securing plate is in such a position, a catch device may be engaged to fix the door securing plate in position relative to the doorknob. In addition to the door securing plate and catch device, embodiments of the invention may comprise a means for capturing the door securing plate in the door frame such that when the door securing plate is rotated to the point that it extends beyond the edge of the door that it enters such a means. Thus, when the door securing plate has been rotated and is captured by the capture means, the door may be prevented from opening, securing the occupants of the room against forced or other undesired entry. In an embodiment of the invention, when the door securing plate is fixed to the doorknob, an occupant of the room need only rotate the knob in the manner ordinarily used to release the latch and allow the door to open. Because the occupant isn't required to take any additional actions to release the door for exit, such an embodiment provides a significantly increased level of safety over known designs.

Further features and advantages of the devices and systems disclosed herein, as well as the structure and operation of various aspects of the present disclosure, are described in detail below with reference to the accompanying figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is an illustration of a known ADA compliant door handle shown mounted on a door;

FIG. 2 is an illustration of an embodiment of the invention in a non-active position;

FIG. 3 is a side view of an embodiment of the invention in a non-active position;

FIG. 4 is an illustration of an embodiment of the invention in an active securing position;

FIG. 5 is an illustration of an embodiment of the invention illustrated as engaged in a door frame capture slot; and

FIG. 6 is an illustration of an embodiment of the invention illustrated in a single motion disengagement position; and

FIGS. 7A and 7B are illustrations of an embodiment of the invention that employs a stop device to locate the securing plate.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

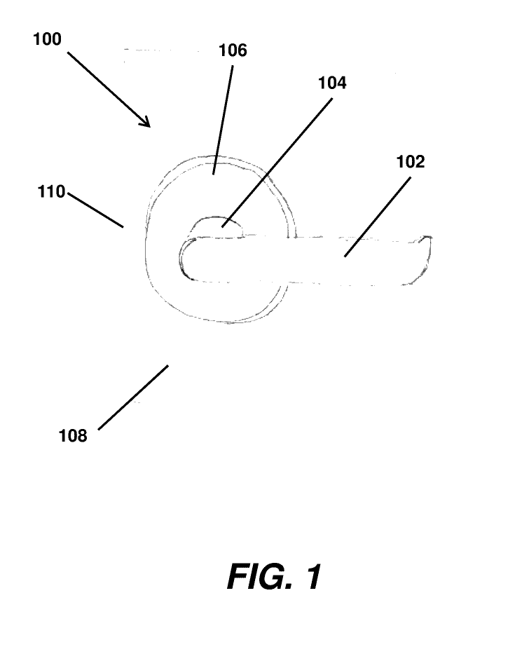

As is illustrated in FIG. 1, a known embodiment of an Americans with Disabilities Act (ADA) compliant door knob 100 may be comprised of a door handle 102, a handle shaft 104 and a mounting plate 106. As illustrated, when in use, such a handle is generally mounted to a door 108 near the edge of the door 110 which makes contact with a door frame 208 (not shown in FIG. 1).

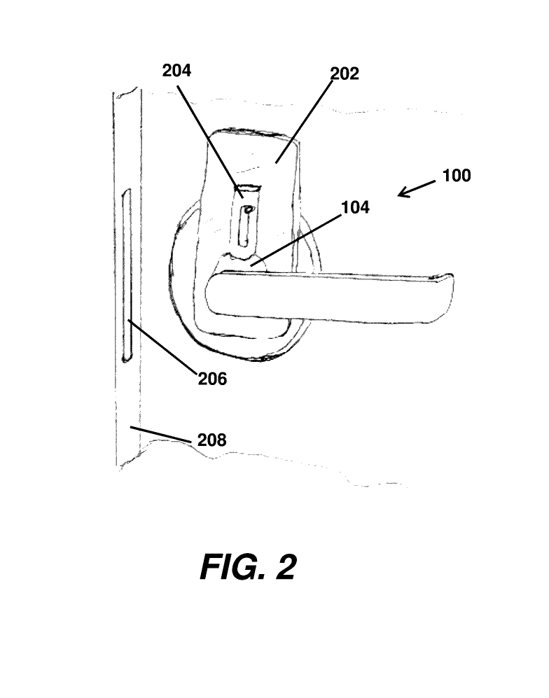

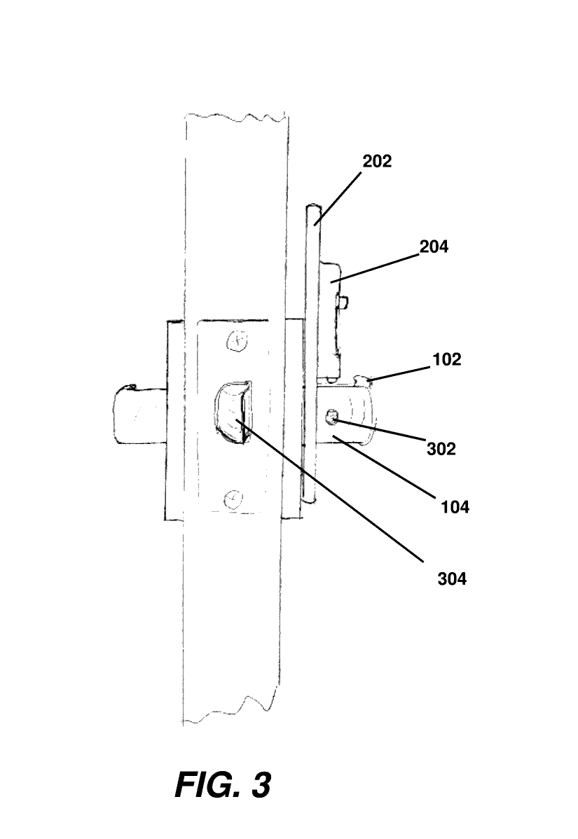

Referring to FIG. 2, an embodiment of the invention may comprise a door securing plate 202 mounted on the handle shaft 104 of a doorknob 100. As illustrated, embodiments of the invention may also comprise a securing latch 204 that may be held in an unlatched position when the door securing plate is not in an active position as is illustrated in FIG. 2. FIG. 3 illustrates a side view of such an embodiment. As shown, the door securing plate 202 is illustrated in a disengaged position. Also shown is an engagement hole 302, which may be engaged by the securing latch 204 when the door securing plate 202 is in the active position. The door securing plate 202 may be fabricated from a rigid material such as, but not limited to steel or aluminum and should be of sufficient thickness so as to avoid deformation when force is applied to the door 208.

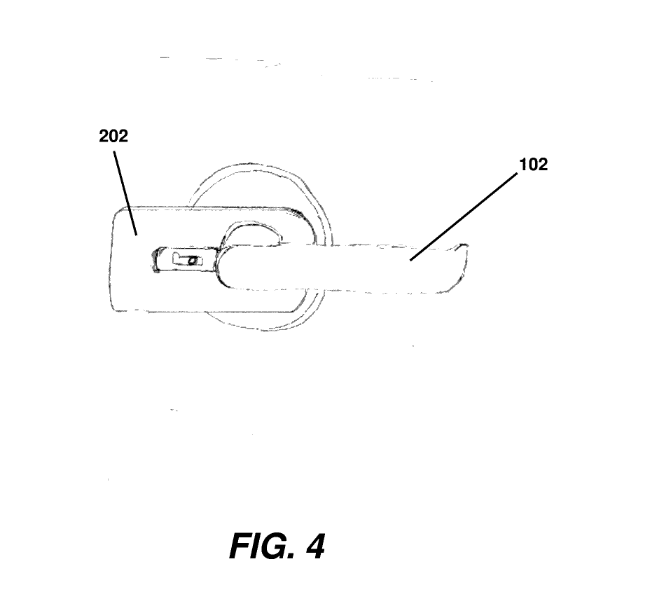

When an occupant or other user wishes to engage the door securing plate 202, such a person may rotate the plate such that the securing latch 204 engages with the engagement hole 302. Once so engaged, the door securing plate may be fixed in a position opposite the handle 102 as illustrated in FIG. 4.

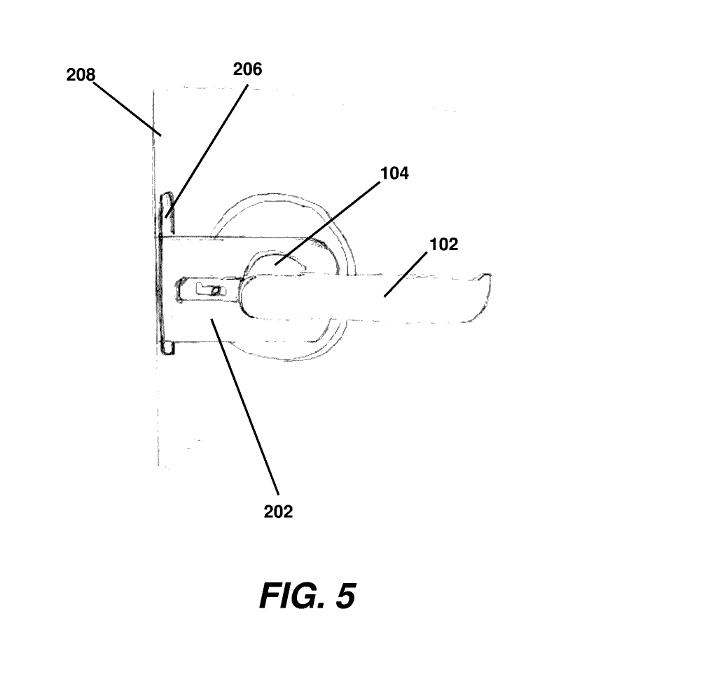

When installed on a door which is mounted in a door frame, a slot may be required to be formed in the door frame in order to capture the door securing plate. Such a slot may need to be open at the top and bottom such that the door securing plate may enter the slot when an occupant of the room rotates the plate from the disengaged position illustrated in FIG. 2 to an engaged position as illustrated in FIG. 4. Such a slot is shown at 206 in FIG. 5. As shown, the slot 206 may be positioned in the door frame 208 such that the slot is located approximately opposite of the door handle shaft 104. The slot 206 may be aligned such that it is aligned with the plane of the securing plate 202 to permit the plate to be easily rotated into the slot when place in the engaged position as illustrated in FIGS. 4 & 5. The use of a slot such as illustrated may allow the door securing plate 202 to be installed on either side of a door (the hinged or non-hinged side) depending upon the orientation of the door relative to the area to be secured against intruders. For example, on a door that opens into the area to be secured, the invention would be installed onto the hinge side of the door and resist attempts to push the door into the secured area. When installed on a door that opens out of the secured area, the invention would be installed on the non-hinge side of the door and resist attempts to pull the door open. Embodiments of the invention may also include a frame to be mounted such that it surrounds the slot 206 to further strengthen the door frame as well as provide a decorative element to disguise the slot.

When installed in such a manner, a user may rotate the door securing plate such that it enters a slot 206 formed in a door frame 208. Once the door securing plate is positioned within the slot 206, the door will be prevented from opening. A preferred ADA compliant doorknob 100 may be configured such that when the door knob is locked, and the opposite (outer) handle (not shown) is rotated, the inner handle remains stationary. In other words, the actions of each handle are independent, with either handle being able to engage the latch 304 (see FIG. 3) and open the door. In such a configuration, the door securing plate 202 will remain engaged in the slot 206 even if the outer handle is rotated because it is not tied to the latch 304. This configuration will serve to prevent the door from being opened until the securing plate 202 is rotated such that it disengages from the slot 206. In such a configuration, locking of the door handle is not required. As such, when a doorknob is not locked, or inadvertently unlocked, the invention may be used to secure a room much more quickly than a device that requires the doorknob to be locked.

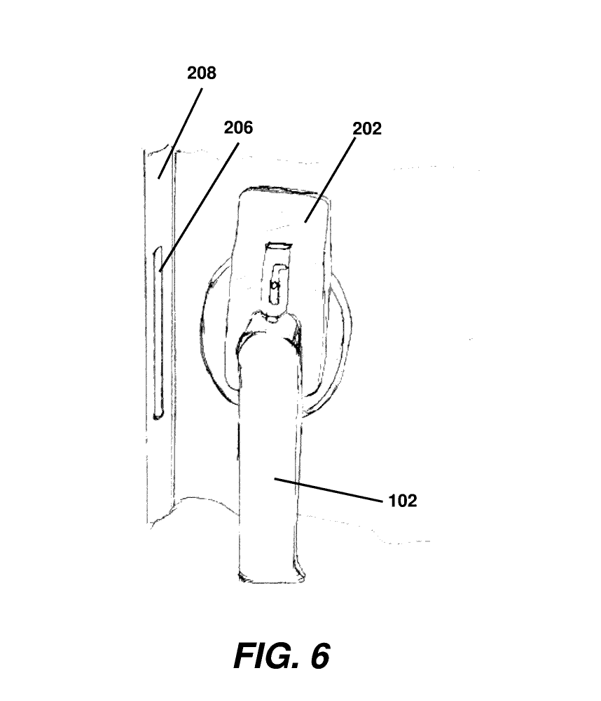

A key feature of the current invention is that the door securing bar is configured such that the securing latch in conjunction with the engagement hole 302 maintains the door securing plate 202 in a position that is relative to the handle 102. This allows a user to quickly and easily disengage the door securing plate 202 from the slot 206 in the door frame. As is illustrated in FIG. 6, in a situation such as a fire, a user may be able to grasp the door handle and rotate it to a position that both disengages the door latching hardware but also the door securing plate 202. As is shown, a user has rotated the door handle 102 to a position that is approximately vertical. The door securing plate 202 has also rotated to a vertical position such that it is no longer engaged by the slot 206 formed in the door frame 208. Once the door latching hardware and the door securing plate 202 have been disengaged, a user may simply push or pull the door open depending upon its configuration.

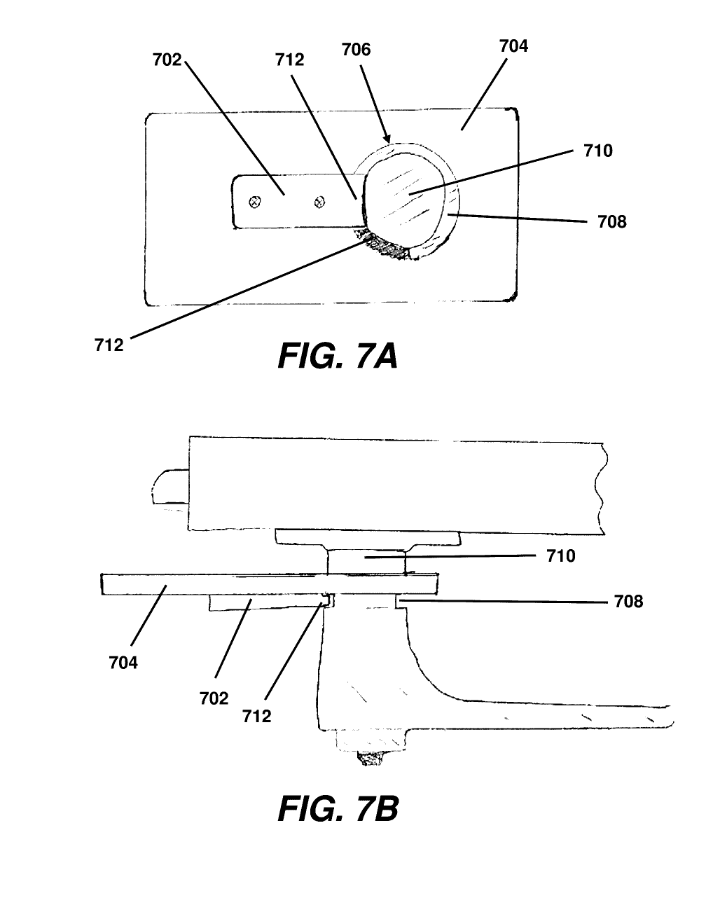

In another embodiment of the invention, the opening formed in the securing plate may be configured to freely rotate into the securing position and then be held in alignment by a stop formed in the door handle shaft. As is illustrated in FIG. 7A, a stop 702 is affixed to the securing plate 704 adjacent to the opening 706. This stop rides in a groove 708 formed in the handle shaft 710 (illustrated in a cross-section view). When the door to which the invention is affixed is desired to be secured, a user may rotate the securing plate 704 into and engaged position (similar to what is illustrated in FIG. 5). As is shown in FIG. 7B, a tap portion 712 the stop 702 engages with a non-grooved portion 714 of the handle shaft 710 and thus prevents the securing plate 704 from rotating past the engaged position. The stop may also function to align the securing plate 704 onto the handle shaft as the tab 712 formed in the stop may engage the groove 708 such that the securing plate is prevented from moving into a position of misalignment.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A doorway entry prevention device for mounting on a door handle shaft comprising:
a securing plate, the securing plate formed with an opening adapted to allow the door handle shaft to pass through the opening such that the securing plate; and
a securing stop affixed to the securing plate, the stop positioned on a first surface of the securing plate such that the stop is positioned at an edge of the opening formed in the securing plate.

2. The device of claim 1, wherein the opening is further adapted to create a friction fit between the securing plate and the door handle shaft.

3. The device of claim 1, wherein the securing stop comprises a tab which is configured to engage a groove formed in the door handle shaft, the groove not fully encircling the door handle shaft.

4. The device of claim 1, wherein the securing stop comprises a latch pin and a spring which is configured to cause the latch pin to be in contact with the handle shaft positioned within the opening formed in the securing plate.

5. The device of claim 1, wherein the securing plate is formed from a rigid material.

6. The device of claim 5, wherein the securing plate is formed from steel.

7. The device of claim 5, wherein the securing plate is formed from aluminum.

8. A method of forming a doorway entry prevention device for mounting on a door handle shaft comprising the steps of:
forming a securing plate;
forming an opening in the securing plate adapted to allow the door handle shaft to pass through the opening; and
attaching a securing stop to a surface of the securing plate where the securing stop is positioned such that an end of the securing stop is substantially aligned with an edge of the opening formed in the securing plate.

9. The method of claim 8, where the securing stop comprises a tab adapted to be positioned into a groove formed in the door handle shaft, the groove not fully encircling the door handle shaft.

10. The method of claim 8, where the securing plate is formed from a rigid material.

11. The method of claim 8, further comprising the step of positioning the securing plate on the handle shaft of a door handle.

12. The method of claim 11, further comprising the step of forming a slot in a door frame, the slot oriented such that the securing device may be rotated to engage the slot.

13. A door handle mounted door securing system comprising:
a door handle;
a handle shaft located near an end of the door handle;
a securing plate comprising an opening that positioned on the handle shaft such that the handle shaft passes through the opening; and
a securing stop affixed to the securing plate.

14. The system of claim 13, wherein the securing stop comprises a tab adapted to be positioned into a groove formed in the door handle shaft, the groove not fully encircling the door handle shaft.

15. The system of claim 13 wherein the securing stop comprises a latch pin, the door handle shaft said shaft comprising a recess configured to receive a latch pin, and the securing stop positioned such that the latch pin engages the handle shaft recess when the securing plate is rotated

16. The system of claim 15 wherein the securing stop further comprises a spring configured to exert pressure on the latch pin such that the latch pin is caused to enter the handle shaft recess when the securing plate is rotated such that the pin aligns with the recess.

17. The system of claim 13, where the securing plate is formed from a rigid material.

18. The method of claim 17, where the securing plate is formed from steel.

19. The system of claim 13, where the securing plate opening is configured such that there is a level of friction between the securing plate and the handle shaft such that the securing plate remains in a fixed position relative to the handle shaft unless a user rotates the securing plate to a second position relative to the handle shaft.
